(19) United States
(12) Patent Application Publication
(10) Pub. No.: US 2004/0054547 A1
(43) Pub. Date: Mar. 18, 2004

(54) Verification of batch items

(76) Inventors: Vincent Rozendaal, Essex (GB); Stephen Kelly, Hertfordshire (GB)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(21) Appl. No.: 10/311,681

(22) PCT Filed: Jun. 12, 2001
(86) PCT No.: PCT/EP01/06662

(30) Foreign Application Priority Data
Jun. 19, 2000 (GB) 0015009.4

(51) Int. Cl. G06F 17/60; H04L 9/00

(52) U.S. Cl. 705/1; 705/80

(57) ABSTRACT

There is described a method of processing a batch of items provided by a first to a second party, the method comprising: generating a record of data relating to the value of a detectable characteristic of each item in the batch; and transmitting the record or an abstract thereof and the batch of items from the first party to the second party by different routes. A system for producing data for use in such a method and a system for verifying data according to such a method are also described.

The present invention relates to methods and systems for processing a batch of items provided by a first to a second party.

When processing batch mail, the volume of mail received, distributed and delivered by a postal service is so great that it prevents the postal service from examining each individual item of mail in a batch to verify that data provided by the mailer to the postal service which pertains to the batch is correct. Conventionally, therefore, postal services have conducted a statistical sampling procedure involving selecting items of mail at random from a batch of mail provided by a mailer to the postal service and examining the sampled items to ensure that any individual sampled item bears a postage indicium having a postage value that is correct for the intended destination of the item, its postage class and so on. If this sampling procedure reveals any items of mail which are not correctly franked, this suggests that the accounting data provided by the mailer to the postal service may not be accurate and further mail submitted by the mailer in question to the postal service may then be examined in greater detail in order to permit gathering of evidence of fraud or detection of some accidental error in the franking process.

However, this conventional technique has a number of disadvantages. Firstly, because the postal service uses a sampling procedure, it may be some weeks before incorrectly franked items of mail are detected, even if the accounting data provided by the mailer to the postal service is not correct. Secondly, the sampling procedure relies upon examination of the postage indicia carried by items of mail and requires that these postage indicia must contain an indication of the value of postage for the items in question. This prevents the submission of batches of unfranked mail, which would clearly be a convenient time-saving measure. Thirdly, even if incorrectly franked items of mail are discovered, the postal service, as already mentioned, must then go on to examine each and every item of mail submitted by the suspect mailer to the postal service in order to determine the extent of the inaccuracy of the accounting data provided by the mailer to the postal service. For all these reasons, a superior method and system for verifying the accounting data are highly desirable.

It is an object of the present invention, therefore, to provide a method of processing a batch of items provided by a first to a second party which permits immediate verification of the batch merely by sampling some of the items in the batch without the necessity to examine all of the items in the batch and without the necessity that the items should bear an indicium containing value information relating to each respective item.

Accordingly, in one aspect, the present invention provides a method of processing a batch of items provided by a first to a second party, the method comprising generating a record of data relating to the value of a detectable characteristic of each item in the batch; and transmitting the record or an abstract thereof and the batch of items from the first party to the second party by different routes.

According to a further aspect of the invention, there is provided a method of processing a batch of items provided by a first to a second party, the method comprising receiving the batch of items at the second party; receiving a record of data relating to the value of a detectable characteristic of each item in the batch or an abstract of said record by a different route from the batch of items: obtaining a sample of items from the batch; deriving from the record or abstract an expected value of the detectable characteristic of the items in the sample; and verifying the batch of items by comparing the expected value of the detectable characteristic thus derived with the actual value of the detectable characteristic of the items in said sample.

According to a further aspect of the invention, there is provided a method of processing a batch of items provided by a first to a second party, the method comprising receiving the batch of items at the second party; receiving a record of data relating to the value of a detectable characteristic of each item in the batch or an abstract of said record by a different route from the batch of items; deriving from the record or abstract an expected value of the detectable characteristic of the items in the batch: and verifying the batch of items by comparing the expected value of the detectable characteristic thus derived with the actual value of the detectable characteristic of the items in said batch.

In a further aspect, the present invention provides a system for processing a batch of items provided by a first to a second party, the system comprising: means for generating a record of data relating to the value of a detectable characteristic of each item in the batch; and means for transmitting the record or an abstract thereof from the first party to the second party by a first route; and means for transmitting the batch of items from the first party to the second party by a second route different from the first route.

According to another aspect of the invention, there is provided a system for processing a batch of items provided by a first to a second party, the system comprising: means for receiving the batch of items at the second party; means for receiving a record of data relating to the value of a detectable characteristic of each item in the batch or an abstract of said record by a different route from the batch of items; means for obtaining a sample of items from the batch; means for deriving from the record or abstract an expected value of the detectable characteristic of the items in the sample; and means for verifying the batch by comparing the expected value of the detectable characteristic thus derived with the actual value of the detectable characteristic of the items in said sample.

The features and advantages of the present invention will be better understood from the following description, given by way of example, in association with the accompanying drawings, in which:

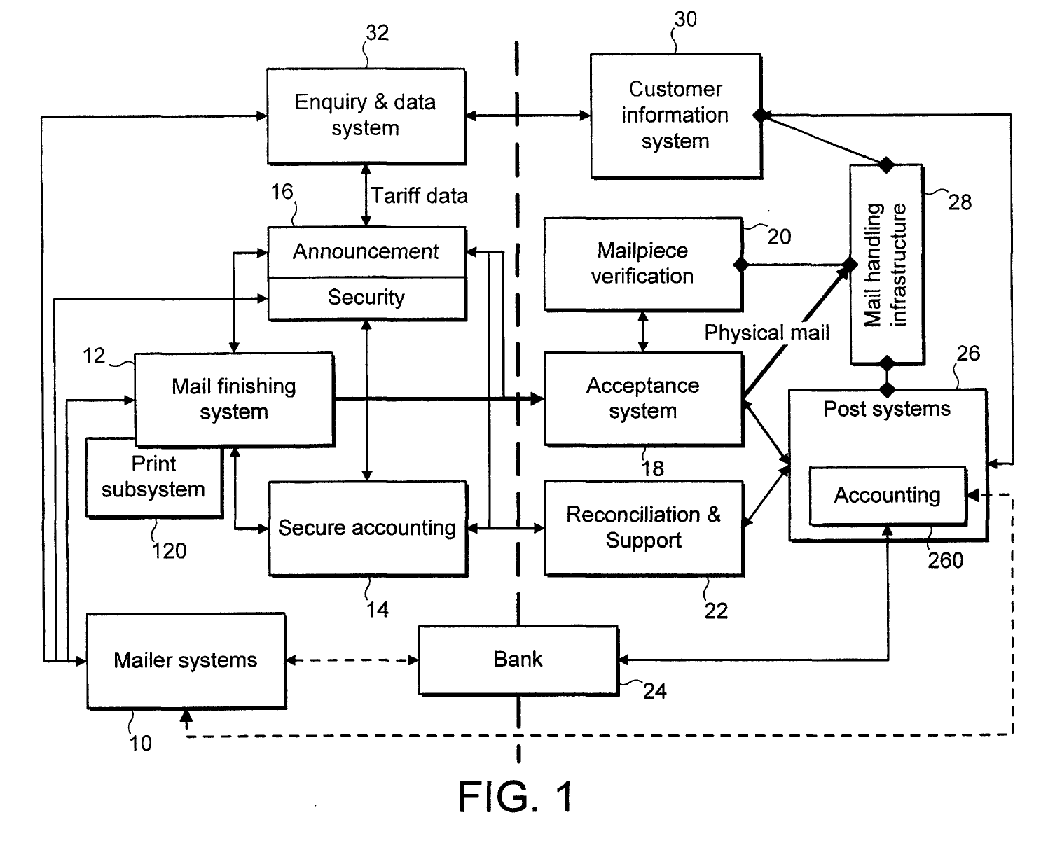

FIG. 1 schematically shows the component parts of a mailer-postal service interface;

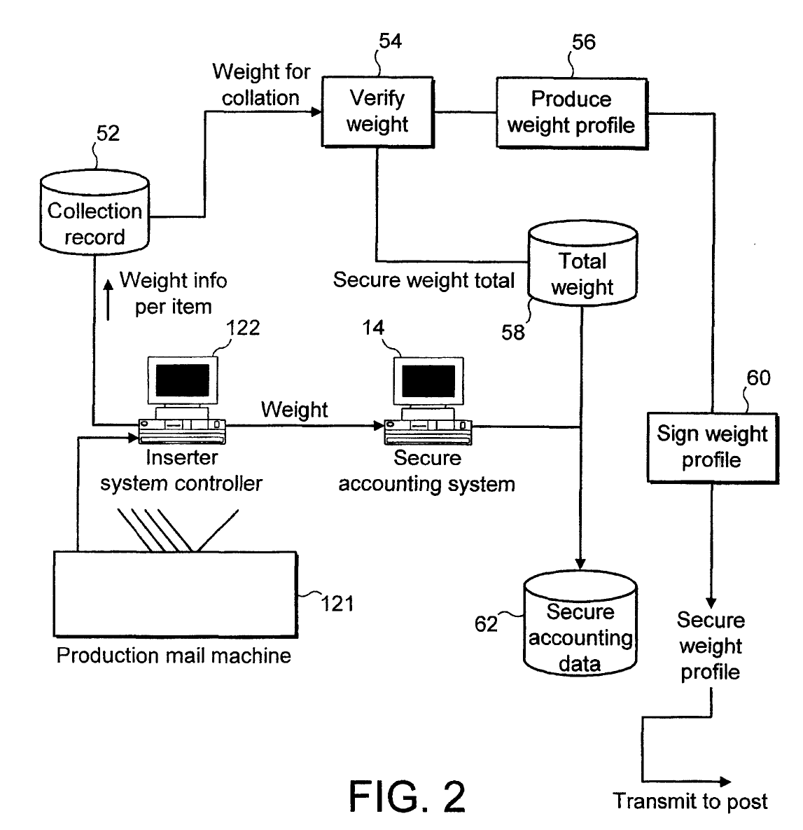

FIG. 2 schematically shows some of the processes carried out on the mailer side of the mailer-postal service interface of FIG. 1, these processes forming part of an embodiment of the method of the invention in order to provide secure accounting data and a secure distribution profile which may then be transmitted from the mailer to the postal service so that the postal service may subsequently verify the secure accounting data;

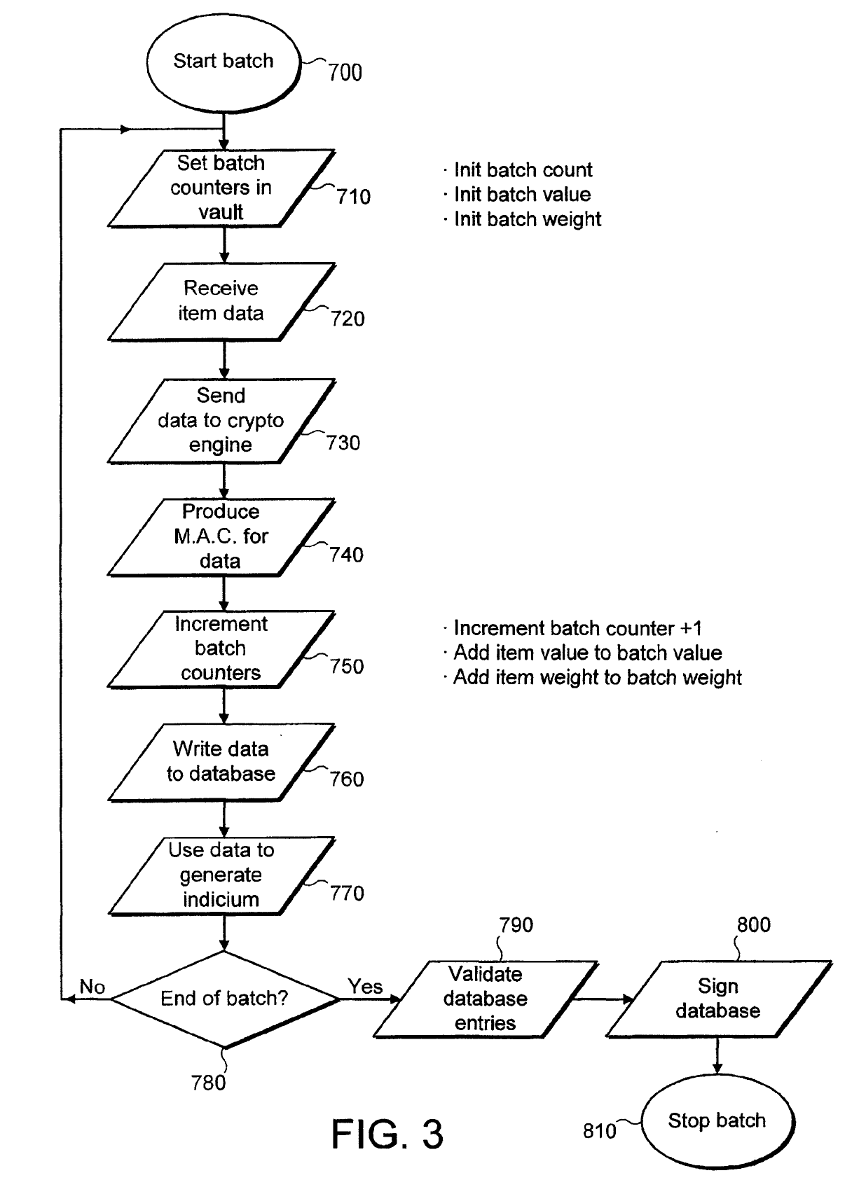

FIG. 3 represents process steps conducted by means of a secure accounting system of the mailer in order to generate a database of information relating to items of mail in a batch of mail;

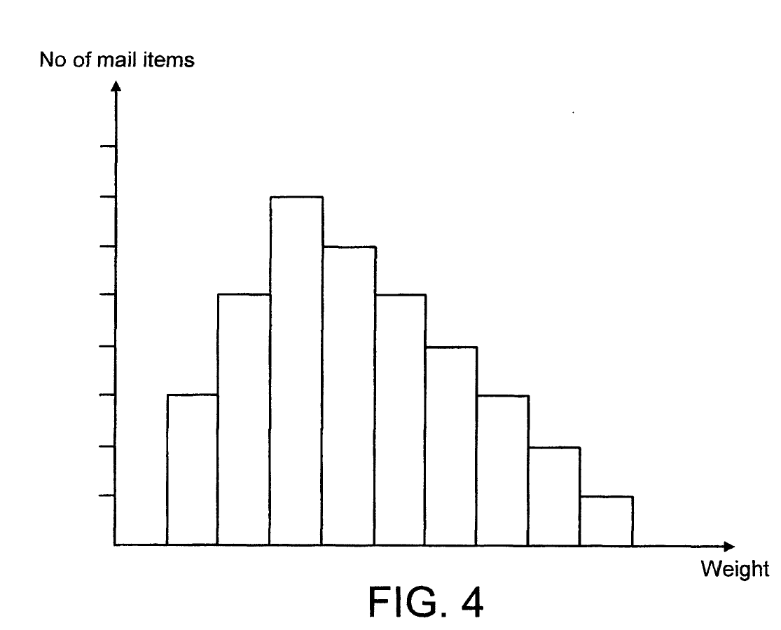

FIG. 4 represents an example of a weight distribution profile of the items of mail in the batch; and

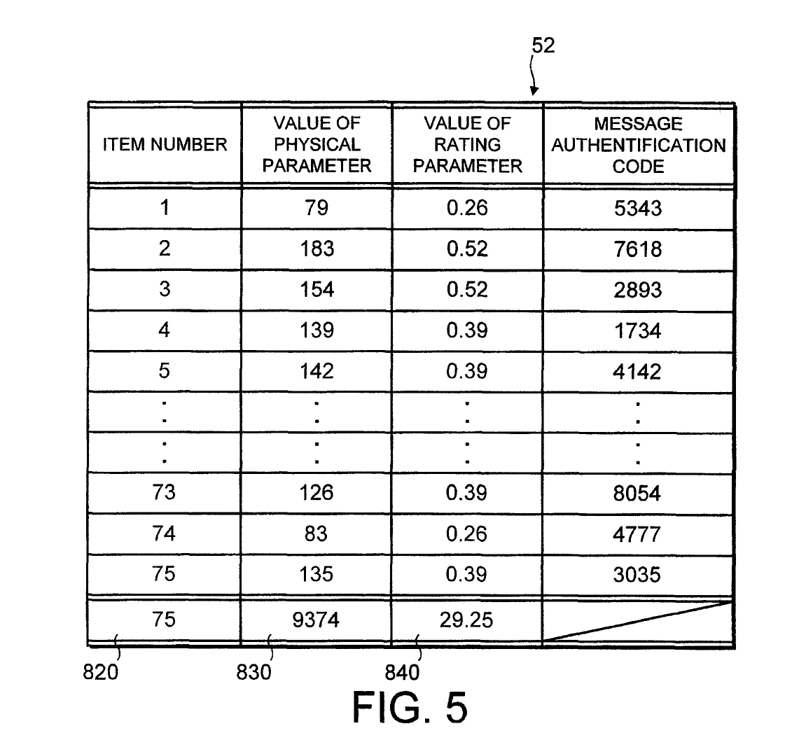

FIG. 5 shows an example of a database generated by means of the method of FIG. 3.

Although the present invention is particularly applicable to data relating to mail generated by a mailer and handed over to a postal service, it may also be applied to any batch of items provided by a first to a second party, where the batch of items must be verified by the second party. As will be explained hereinafter, the verification method uses a record of data relating to a detectable characteristic of the items in the batch.

The data in question may be that relating to mail generated by a mailer and handed over to a postal service which distributes and delivers the generated mail in return for appropriate payment provided by the mailer. In such a case, therefore, the data in question may be data containing information pertaining to the batch of mail of the type “75 items of mail, postage value=£29.25, weight=9.374 kilograms”. This data is then used by the postal service as the basis for charging the mailer for distribution and delivery of the mail to which the accounting data relates. It is therefore important that the data in question should be secured against fraud and/or accidental error, particularly since the data in question is derived exclusively from the mailer without any input of information from the postal service.

A mailer-postal service interface may be represented schematically as shown in FIG. 1, in which the enumerated boxes represent functional components of the interface and the vertical dashed line down the centre of FIG. 1 divides functional components of the interface generally associated with the mailer (shown in the left-hand side of FIG. 1) from functional components of the interface generally associated with the postal service (shown in the right-hand side of FIG. 1). In the following, the mailer may also be referred to as a customer of the postal service.

The mailer-postal service interface shown in FIG. 1 is suitable for handling batches of mail, the hand-over of which from the mailer to the postal service may be announced by means of a statement of mailing submission (SMS). A statement of mailing submission is a batch record sent from the mailer to the postal service and describing the composition of a submission of mail. The process of hand-over, of one or more submissions of mail, for acceptance by the postal service is called induction. Where several submissions are handed over as part of a single transaction, the set of submissions concerned is documented in a statement of induction (Sol). A statement of induction is a message defining the set of submissions inducted into the postal system as part of a single hand-over transaction. A submission is part of a mailing which is inducted (possibly with submissions from other mailings) as a single unit. A mailing is a logical collection of mail, from the perspective of the mailer. Normally, a mailing will comprise mail which it is logical to generate as a unit and will be the unit for which the mailer expects to be invoiced. For physical production purposes, mailings may be broken down into one or more production batches. For induction purposes. on the other hand, they are broken down into submissions, with individual submissions being separately inducted. This may occur, for example, when the production of a mailing is spread over several days. Some postal services, however, may require each submission to be treated as a separate mailing, or may limit the number of submissions into which a mailing is split.

The functional components enumerated in FIG. 1 will now be described.

A mailer systems component 10 represents customer data processing systems, dealing with normal business and office functions including mail generation and company accounting. For example, such data processing systems include desktop computers running application programs for word processing and for maintaining internal records and accounts.

A mail finishing system component 12 represents specialised equipment and control systems used for converting raw documents derived from the mailer systems 10 into finished mail, ready for hand-over to the postal service. Such equipment includes inserting, enveloping and addressing or labelling machines, postage metering equipment, bundling and wrapping equipment, etc.

The mail finishing system 12 comprises a mail finishing print sub-system 120 which is responsible for the composition and printing of proof-of-payment indicia on mail items. It receives data required for a digital proof-of-payment indicium to be added to a mail item, which may be encoded in appropriate symbology, and controls the process for the printing thereof on mail items.

A secure accounting system 14 is responsible for maintaining secure accounting information for items of mail produced by mail finishing system 12 and comprises a secure vault which returns to its controlling IT system a digital signature for use in the authentication of postal payment indicia. At the end of each mail production run by the mailer, the vault may also provide a cryptographic signature for an SMS (batch record).

During a mail run, an announcement system 16 (described below) passes postal rating information (e.g. the mail type and weight) received from the customer and/or the mail finishing system 12 to the secure accounting system 14. The secure accounting system 14 supports postage payment security requirements by means of encryption and authentication, maintains accounting information relating to payments effected by the mailer, be they pre-paid or a credit balance outstanding and unused payment tokens, returns a postage amount based on input parameters, together with a digital signature or other payment evidencing token, and maintains a summary of mailpiece types so that an SMS can be generated at the completion of the mail run.

To fulfil these functions, the secure accounting system 14 uses cryptographic techniques, based on design-specific algorithms and key management systems. It communicates with the other devices and systems primarily through the announcement system 16, but may communicate directly with a reconciliation and support system 22 used for maintenance of the mailer's systems and re-crediting of the mailer's postage account.

The announcement system 16 is responsible for controlling and interfacing with other components to ensure that the mail produced by the mailer is properly accounted for and provided with appropriate proof of payment in the form of digital indicia. Its main purpose is to complement the mailer and or mail finishing systems 10, 12, adding to them the functionality needed to control the use of the secure accounting system 14, which accounts for and instructs printing of the digital indicium onto each mailpiece. The accounting system 14 is responsible for the compilation of data for SMS generation but the electronic submission of these to the postal service's acceptance system 18 and the processing of responses received from that system are conducted by the announcement system 16.

The acceptance system 18 supports the acceptance of mail into the postal service's mail handling environment and controls the hand-over of mail from the mailer to the postal service. This hand-over may take place either on the mailer's premises or in postal acceptance offices.

The acceptance system 18 accepts, records and acknowledges the arrival from mailers of SMS's (batch records). Data provided in each SMS are passed to the postal service acceptance system 18 and to the mailpiece verification system 20 for revenue protection purposes.

The acceptance system 18 provides mail acceptance staff with an automated capability to verify incoming mail based on each submitted SMS. Where a mail submission can be reconciled with an SMS which describes it, the SMS is passed to the postal service accounting system 260 for accounting verification, revenue reconciliation and, where appropriate, post-invoicing purposes. Receipt and acceptance of the mail submission is acknowledged to the customer's announcement system 16 via an electronic link.

If no reconciliation is possible, the acceptance system 18 informs a postal service operator. When there is a justifiable suspicion that fraud has been attempted by the mailer, the acceptance system 18 assists in obtaining evidence of this.

Data for validation may also be gained from sampling individual mailpieces in the submission in question.

The mailpiece verification system 20 processes and authenticates the payment evidence and/or customer identification provided by the indicium printed on each mailpiece and collects information needed for accounting or accounting verification. In particular, it accepts data from individual mailpieces collected by the mail handling infrastructure, checks that such data presents acceptable evidence of payment for the services required, compares the data for consistency with information from the SMS acknowledges to the acceptance system 18 the validity of the SMS involved, and passes data on payment evidence for payment management and fraud detection purposes to the acceptance system 18.

Reconciliation and support system 22 is a collective name for a number of systems concerned with the management of postage accounting devices installed on the mailer's premises. Such systems provide postage value re-setting services, i.e. services for the re-setting or re-crediting of postage payment devices, for example to the secure accounting system 14, and monitoring and maintenance services, i.e. services concerned with ensuring the correct functioning and reliability of postage payment devices and with detecting and preventing attempts to tamper with them. Again, these services primarily concern the secure accounting system 14.

The reconciliation and support system 22 may be owned and operated either by a postal administration, or by a third party, working on behalf of the postal administration concerned.

A bank component 24 represents the means by which the mailer effects payment to the postal service, normally through the commercial or postal banking system.

Post systems 26 represent the postal data processing infrastructure, including systems for customer account management and traditional accounting (bookkeeping) systems.

The mail handling infrastructure component 28 represents infrastructure for automated mail processing, including optical character recognition (OCR) and bar-code sorting machines, delivery sequencing equipment, etc. The process control systems used to manage this infrastructure are also included.

For some purposes, mailpiece data capture can be provided by hand-held scanning devices associated directly with the verification system 20, rather than by other infrastructure components.

A customer information system 30 is a system which supports the electronic reporting of, and access to, information on the acceptance and processing of the mailer's special category mail, the provision of postal information (both public and customer-contract specific) to assist the mailer in preparing mail for submission to the postal service, and the expression and recording of the mailer's preferences for the way mail is delivered to them.

An enquiry and data system 32 is the mailer's complement to the customer information system 30. It can be implemented using a standard worldwide web browser to access the customer information system 30.

In FIG. 1, physical mail follows the path represented by the bold arrow from mail finishing system 12 to acceptance system 18 and thence to mail handling infrastructure 28. Other arrows in FIG. 1 represent interchange of information relating to mail contents, including but not restricted to, for example, mail type and weight and accounting information and information for incorporation as part of the physical mail itself. Diamond-headed lines in FIG. 1. connecting component boxes 20, 26, 28 and 30 represent data integration conducted by the postal service.

FIG. 2 schematically shows some of the processes carried out on the mailer side of the mailer-postal service interface shown in FIG. 1. These processes form that part of an embodiment which provides secure accounting data and the SMS which may then be transmitted from the mailer to the postal service to allow the postal service to subsequently verify the batch of items. Production mail machine 121 in FIG. 2 is an example of a mail finishing system represented by box 12 in FIG. 1 and may, for example, be an inserter machine for inserting collations of documents into envelopes. Thereby to create items of mail. Production mail machine 121 generates in an inserter system controller 122 weight information concerning items of mail processed by mail machine 121. The weight information generated in inserter system controller 122 may be a measured weight for each item of mail processed by mail machine 121 if the mail machine 121 comprises a scale for weighing the items of mail or may alternatively be a calculated weight derived from other properties of each item of mail, such as the number of collations each item of mail contains. Inserter system controller 122 uses the weight information thus generated to create a collation record 52 of the weight information for each item of mail, for transmission as an SMS. Furthermore, the inserter system controller passes the weight information to secure accounting system 14.

The steps conducted by secure accounting system 14 on the basis of this weight information are represented in FIG. 3. Initially, at step 700, secure accounting system 14 instructs mail machine 121 to start processing a new batch of mail. At step 710, the secure accounting system 14 accordingly sets batch counters in the secure vault thereof to initial values representing the initial count of the number of items of mail in the batch, the initial postage value of the batch and the batch's initial weight. Usually, the initial count of the number of mail items in the batch, and the initial postage value and weight of the batch are all set to zero, although the initial weight may include a tare to compensate for the weight of a pallet or tray to be used for transporting the batch to the postal service.

Then, in step 720, the secure accounting system 14 receives the weight and postage value data for the first item of mail in the batch from inserter system controller 122. At step 730, it sends this data to a crypto engine in the secure vault, which at step 740 produces a message authentication code (MAC) based on the weight and postage value data for the item of mail in question. A message authentication code (MAC) is a cryptographically generated code, typically comprising a string of numbers and/or letters, which is generated from a string of data (or message) using a cryptographic algorithm, in order to permit authentication of the message in question either by comparison of the MAC with the result of applying the same cryptographic algorithm to the same message again at a later time or by comparison of the message itself with the result of decrypting the MAC. In the present context, the weight and postage value data for an item of mail provides a message suitable for encryption using the cryptographic algorithm. The cryptographic algorithm, which is provided by the crypto engine in the secure vault of the accounting system 14, may, for example, be implemented by a triple DES symmetric algorithm within the ownership of the postal service.

The weight and postage value data for the first item of mail are accordingly tagged with their message authentication code and then the batch counters in the vault are incremented at step 750 by incrementing the batch counter for the number of items of mail by one, adding the value of postage for the item of mail in question to the initial batch value and adding the weight of the item of mail to the initial batch weight. The tagged weight and postage value data for the item in question are then written to a database of the secure accounting system in step 760. Finally, in step 770, the weight and postage value information is used by the secure accounting system 14 to generate an indicium for the item of mail in question which is transmitted to the mail machine 121 via the controller 122 for application to the item of mail by print subsystem 120.

Next, at step 780, the secure accounting system 14 checks whether the end of the batch has been reached. If nor it returns in a loop to step 720 to receive weight and postage value data from the inserter system controller 122 for the next item of nail in the batch. Steps 720 to 770 are repeated for the next item of mail in the batch until at step 780, the accounting system 14 determines that the end of the batch has been reached. If so, the database entries in the accounting system are validated in step 790.

Validation of the database entries by the secure accounting system 14 may take one of several forms. A “horizontal” validation of one or more of the lines of data, each corresponding to one of the items of mail in the batch, may be conducted by comparison of the MAC for the line of data in question with the data contained in that line. Thus, referring to FIG. 5, which shows an example of the database generated by the secure accounting system 14, message authentication code “5343” may be compared with the data represented by item number “1”, weight “79” and postage value “0.26”. This “horizontal” verification may take the form of regeneration of a MAC from the three data items in question and comparison of the regenerated MAC with the MAC represented in the right-hand column of the database. Alternatively, it may take the form of description of the MAC from the database and comparison of the result of this decryption with the data entries in that line of data. This “horizontal” validation may be conducted for all of the lines of data in the database or may be conducted using a statistical sampling procedure for convenience in the event of the database containing data for a large number of items of mail. Alternatively, the validation procedure represented by step 790 in FIG. 3 may be a “vertical” validation in which one or more of the following comparisons is conducted. Firstly, the total number of items in the batch stored in the batch counter of the secure vault may be compared with the total number of items 820 recorded in the database, which in the example of FIG. 5 is “75”. Secondly, the total value of the weight of the items in the batch stored in the batch counter of the secure vault may be compared with the total value of the weight 830 recorded in the database, which in the example of FIG. 5 is “9374”. Thirdly, the total value of the postage for the items in the batch stored in the batch counter in the secure vault may be compared with the total value of the postage 840 recorded in the database, which in the example of FIG. 5 is “29.25”. As mentioned, one or more of these different “vertical”validations may be carried out. Moreover, both “horizontal” and “vertical” validations may be conducted, depending upon the level of security that is required.

Following validation, the database is signed with an electronic signature in step 800, before the secure accounting system 14 instructs the mail machine 121 to stop production of the batch in step 810. The secure accounting system 14 generates the electronic signature using an encryption algorithm contained in the secure vault, which may be the same or a different algorithm to that used to generate the MACs. Following application of the electronic signature, the database becomes secure. The database generated by the process steps shown in FIG. 3 therefore represents a complete record of weight and postage value information for the items of mail in the batch, each line of weight and postage value data being accompanied by a MAC, and the entire record for that batch having been validated and signed with an electronic signature. This final form of the database may then form part of an electronic message which may be passed by the secure accounting system 14 to the announcement system 16 for transmission to the postal service as an SMS.

Returning to FIG. 2, it can be seen that during processing of a batch of mail by production mail machine 121 under control of inserter system controller 122, the contents of the secure vault of accounting system 14, including running totals of the weight and value of postage for the batch and the number of items of mail in the batch, are constantly changing. Upon completion of production of the batch, however, secure accounting system 14 has generated secure accounting data 62 of the type “75 items of mail, postage value=£29.25, weight=9.374 kilograms”, including in one of the batch counters of the vault a secure record 58 of the total weight of the batch.

in step 54, the announcement system 16 verifies the total weight of the batch record 52 by comparing the secure record 58 of the total weight of the batch derived from the vault of the secure accounting system 14 with the total weight for the batch derived from the collation record 52 generated from the inserter system controller 122. In step 56, announcement system 16 may further produce a weight distribution profile for the batch from the record 52. An example of such a weight distribution profile is shown in FIG. 4. In this example, the collation record 52 has been analysed by allocating weight ranges to the items of mail in the batch and then counting the number of items of mail falling within each of the allocated weight ranges. In the example shown in FIG. 4, therefore, there are represented ten weight ranges which have been allocated to the batch, which respectively contain 0, 3, 5, 7, 6, 5, 4, 3, 2 and 1 items of mail, starting from the lowest weight range and moving towards the highest weight range. Although FIG. 4 shows a histogram which can be constructed from this analysis of the weight distribution of the batch, in reality, the analysis of the weight distribution performed by announcement system 16 will actually result in a string of electronic data. Thirdly, in step 60, using its security component shown in FIG. 1, the announcement system 16 adds an electronic signature to the electronic data representing the weight distribution profile thus derived.

Finally, the electronically signed. and hence secure, weight record generated by announcement system 16 is transmitted to the postal service via the electronic link therewith. This transmitted information forms the statement of mailing submission for the batch of mail in question. The SMS generated by announcement system 16 provides the postal service with an independent check on the accuracy of the items of mail in the batch. This check can be carried out upon induction of the physical mail from the mailer into acceptance system 18 of the postal service shown in FIG. 1 by sampling the actual weight or weight distribution of items of mail from the batch and comparing the results with the SMS received from announcement system 16.

It will be appreciated that the procedure shown in FIG. 2 may be simplified by omitting step 56. The secure weight profile sent to the post will then, in the simplest case, just contain an indication of the total weight of the batch. Moreover, other detectable characteristics of the batch may be used instead of or in addition to weight. For example, the amount of postage paid for each item, or the size or thickness of each item, may be used to generate a histogram record similar to FIG. 4. The postal service could then check the correlation between the physical mail and the record by sampling items from the batch.

Verifying the items by comparing the distribution profile with the distribution of the physical parameter amongst the items in the batch is achievable in the following manner. The distribution profile transmitted to the second party contains information on the total number of items in the batch and the total value of the physical parameter for the items in the batch which are independent of the information pertaining to the total number of items in the batch and the accumulated total value of the physical parameter for the items in the batch contained in the accounting data. Therefore, the correctness of the accounting data may be confirmed by comparison with the distribution profile. The validity of the distribution profile itself for performing this check on the accounting data is confirmable by comparing the distribution profile with a distribution derived from sampling the items in the batch transmitted to the second party. If the distribution profile transmitted to the second part is in any way inaccurate, then it will appear skewed or otherwise distorted in comparison to the distribution profile derived from the items themselves. Because sampling the items in the batch is a statistical procedure, it is not necessary to examine each and every item in the batch to derive the distribution profile amongst the items in the batch. Moreover, since the sampled items are examined only for the value of their physical parameter, there is no necessity that the items should bear an indicium containing information relating to each respective item.

1. A method of processing a batch of items provided by a first to a second party, the method comprising:
generating a record (52) of data relating to the value of a detectable characteristic of each item in the batch; and
transmitting the record or an abstract thereof and the batch of items from the first party to the second party by different routes.

2. A method according to claim 1, further comprising:
receiving the record or abstract and the batch of items at the second party;
obtaining a sample of items from the batch;
deriving from the record or abstract an expected value of the detectable characteristic of the items in the sample; and
verifying the batch of items by comparing the expected value of the detectable characteristic thus derived with the actual value of the detectable characteristic of the items in said sample.

3. A method according to claim 1, further comprising:
receiving the record or abstract and the batch of items at the second party;
deriving from the record or abstract an expected value of the detectable characteristic of the items in the batch; and
verifying the batch of items by comparing the expected value of the detectable characteristic thus derived with the actual value of the detectable characteristic of the items in said batch.

4. A method according to claim 1, 2 or 3 further comprising, prior to the step of transmitting the record (52) of data:
accumulating a count of the total value (58) of the detectable characteristic of the items in the batch; and
comparing (54) the total value (58) of the detectable characteristic thus accumulated with a total value of the detectable characteristic derived from said record (52).

5. A method according to any one of the preceding claims, further comprising, prior to the step of transmitting the record (52) of data:
accumulating a count of the total number of items in the batch.

6. A method according to claim 4 or claim 5, wherein the step of accumulating a count of the total value of the detectable characteristic and/or the total number of the items in the batch is conducted in a secure vault.

7. A method according to any one of the preceding claims, further comprising, after the step of transmitting the record or abstract and the batch of items:
deriving an expected total value of the detectable characteristic of the items in the batch from the record or abstract; and
comparing the expected total value thus derived with the actual total value of the detectable characteristic of the items in the batch.

8. A method according to any one of the preceding claims, further comprising, after the step of transmitting the record or abstract and the batch of items:
deriving an expected number of consecutive items in the batch having the same value of the detectable characteristic as each other from the record or abstract; and
comparing the expected number thus derived with the actual number of consecutive items in the batch having said same value of the detectable characteristic as each other.

9. A method according to any one of the preceding claims, wherein the record provides a distribution profile of the detectable characteristic amongst the items in the batch.

10. A method according to any one of the preceding claims, wherein the record or abstract is transmitted from the first party to the second party in electronic format.

11. A method according to claim 10, wherein the record or abstract is transmitted via the internet.

12. A method according to any one of the preceding claims, wherein the detectable characteristic comprises a physical parameter of the items in the batch.

13. A method according to claim 12, wherein the physical parameter is the weight of the items in the batch.

14. A method according to claim 12, wherein the physical parameter is the size format of the items in the batch.

15. A method according to any one of the preceding claims, wherein the detectable characteristic comprises a rating parameter of the items in the batch.

16. A method according to any one of the preceding claims, wherein the first party is a mailer, the second party is a postal service and the items in the batch are items of mail.

17. A method according to claim 16 as dependent on claim 15, wherein the rating parameter is the postage value of the items of mail.

18. A method according to claim 16 as dependent on claim 15, wherein the rating parameter is a postal service code corresponding to the postage class and/or mode of sending of the items of mail.

19. A method according to claim 16, wherein the detectable characteristic comprises the destination address of the items of mail.

20. A method according to claim 16 or any one of claims 17 to 19 as dependent on claim 15, further comprising:
generating a postage indicium for each item of mail in the batch based on the data relating to the value of the detectable characteristic of said item;
associating the respective postage indicia with the respective items of mail prior to transmitting the batch from the mailer to the postal service; and
after receiving the batch of items at the postal service, examining the postage indicia of the items of mail sampled from the batch, thereby to derive the actual value of the detectable characteristic of the sampled item for comparison with the expected value of the detectable characteristic derived from the record or abstract.

21. A method according to any one of the preceding claims, further comprising cryptographically protecting (60) the record or abstract before transmitting it to the second party.

22. A method according to claim 21, wherein the step of cryptographically protecting the record or abstract comprises attaching an electronic signature thereto.

23. A method of processing a batch of items provided by a first to a second party, the method comprising:
receiving the batch of items at the second party;
receiving a record of data relating to the value of a detectable characteristic of each item in the batch or an abstract of said record by a different route from the batch of items;
obtaining a sample of items from the batch;
deriving from the record or abstract an expected value of the detectable characteristic of the items in the sample; and
verifying the batch of items by comparing the expected value of the detectable characteristic thus derived with the actual value of the detectable characteristic of the items in said sample.

24. A method of processing a batch of items provided by a first to a second party, the method comprising:
receiving the batch of items at the second party;
receiving a record of data relating to the value of a detectable characteristic of each item in the batch or an abstract of said record by a different route from the batch of items;
deriving from the record or abstract an expected value of the detectable characteristic of the items in the batch; and
verifying the batch of items by comparing the expected value of the detectable characteristic thus derived with the actual value of the detectable characteristic of the items in said batch.

25. A method according to claim 23 or 24, further comprising:
deriving an expected total value of the detectable characteristic of the items in the batch from the record or abstract; and
comparing the expected total value thus derived with the actual total value of the detectable characteristic of the items in the batch.

26. A method according to any one of claims 23 to 25 further comprising:
deriving an expected number of consecutive items in the batch having the same value of the detectable characteristic as each other from the record or abstract; and
comparing the expected number thus derived with the actual number of consecutive items in the batch having said same value of the detectable characteristic as each other.

27. A method according to any one of claims 23 to 26, wherein the record provides a distribution profile of the detectable characteristic amongst the items in the batch.

28. A method according to any one of claims 23 to 27, wherein the record or abstract is received from the first party by the second party in electronic format.

29. A method according to claim 28, wherein the record or abstract is received via the internet.

30. A method according to any one of claims 23 to 29, wherein the detectable characteristic is a physical parameter of the items in the batch.

31. A method according to claim 30, wherein the physical parameter is the weight of the items in the batch.

32. A method according to claim 30, wherein the physical parameter is the size format of the items in the batch.

33. A method according to any one of claims 23 to 32, wherein the detectable characteristic is a rating parameter of items in the batch.

34. A method according to any one of claims 23 to 33, wherein the first party is a mailer, the second party is a postal service and the items in the batch are items of mail.

35. A method according to claim 34 as dependent on claim 33, wherein the rating parameter is the postage value of the items of mail.

36. A method according to claim 34 as dependent on claim 33, wherein the rating parameter is a postal service code corresponding to the postage class and/or mode of sending of the items of mail.

37. A method according to claim 34, wherein the detectable characteristic comprises the destination address of the items of mail.

38. A method according to claim 34 or any one of claims 35 to 37 as dependent on claim 34, wherein each item of mail in the batch has associated therewith a postage indicium based on the data relating to the value of the detectable characteristic of said item, and the method further comprises:
examining the postage indicia of the item of mail sampled from the batch, thereby to derive the actual value of the detectable characteristic of the sampled items for comparison with the expected value of the detectable characteristic derived from the record or abstract.

39. A system for processing a batch of items provided by a first to a second party, the system comprising:
means (121,122) for generating a record (52) of data relating to the value of a detectable characteristic of each item in the batch; and
means for transmitting the record or an abstract thereof from the first party to the second party by a first route; and
means for transmitting the batch of items from the first party to the second party by a second route different from the first route.

40. A system according to claim 39, further comprising:
means (18) for receiving the record or the abstract at the second party;
means (18) for receiving the batch of items at the second party;
means (22) for obtaining a sample of items from the batch;
means (22) for deriving from the record or abstract an expected value of the detectable characteristic of the items in the sample; and
means (22) for verifying the batch of items by comparing the expected value of the detectable characteristic thus derived with the actual value of the detectable characteristic of the items in said sample.

41. A system according to claim 39, further comprising:
means (18) for receiving the record or the abstract at the second party;
means (18) for receiving the batch of items at the second party;
means (22) for deriving from the record or abstract an expected value of the detectable characteristic of the items in the batch; and
means (22) for verifying the batch of items by comparing the expected value of the detectable characteristic thus derived with the actual value of the detectable characteristic of the items in said batch.

42. A system according to claim 40 or 41, further comprising:
means (14) for accumulating a count of the total value (58) of the detectable characteristic of the items in the batch; and
means (16) for comparing the total value (58) of the detectable characteristic thus accumulated with a total value of the selectable characteristic derived from said record (52).

43. A system according to any one of claims 39 to 42, further comprising:
means (14) for accumulating a count of the total number of items in the batch.

44. A system according to claim 42 or claim 43, wherein the means (14) for accumulating a count of the total value of the detectable characteristic and/or the total number of the items in the batch comprises a counter in a secure vault.

45. A system according to any one of claims 40 to 44 further comprising:
means for deriving an expected total value of the detectable characteristic of the items in the batch from the record or abstract; and
means for comparing the expected total value thus derived with the actual total value of the detectable characteristic of the items in the batch.

46. A system according to any one of claims 40 to 44 further comprising:
means for deriving an expected number of consecutive items in the batch having the same value of the detectable characteristic as each other from the record or abstract; and
means for comparing the expected number thus derived with the actual number of consecutive items in the batch having said same value of the detectable characteristic as each other.

47. A system according to any one of claims 39 to 46, further comprising means for transmitting the abstract from the first party to the second party in electronic format.

48. A system according to claim 47, wherein the means for transmitting the abstract in electronic format comprises means for transmitting the record or abstract via the internet.

49. A system according to any one of claims 39 to 48, wherein the detectable characteristic comprises the weight of the items in the batch and the means (121) for processing said batch of items comprises a scale for determining the weight of each item.

50. A system according to any one of claims 39 to 49, wherein the detectable characteristic comprises the size format of the items in the batch and the means (121) for processing said batch of items comprises means for measuring the size format of each item.

51. A system according to any one of claims 39 to 50, wherein:
the first party is a mailer, the second party is a postal service and the items in the batch are items of mail,
the means for processing the batch of items comprises a mail production machine (121) of the mailer for inserting collations of documents into envelopes, thereby to generate said items of mail, under control of an inserter system controller (122) which generates the record of data relating to the value of a detectable characteristic of each item in the batch.

52. A system according to claim 51, further comprising:
means for generating a postage indicium for each item of mail in the batch based on the data relating to the value of the detectable characteristic of said item, and wherein
the mail production machine (121) comprises a print sub-system (120) for associating the respective postage indicia with the respective items of mail prior to transmission of the batch from the mailer to the postal service.

53. A system according to claim 52, further comprising:
means for examining the postage indicia of the items of mail sampled from the batch, thereby to derive the actual value of the detectable characteristic of the sampled items for comparison with the expected value of the detectable characteristic derived from the record or abstract.

54. A system according to any one of claims 39 to 53, further comprising means for cryptographically protecting the record or abstract before transmitting it to the second party.

55. A system according to claim 54, wherein the means for cryptographically protecting the abstract comprises means for attaching an electronic signature thereto.

56. A system according to claim 54 or claim 55, wherein the means for cryptographically protecting the abstract is located in a secure vault.

57. A system for processing a batch of items provided by a first to a second party, the system comprising:
means (18) for receiving the batch of items at the second party;
means (18) for receiving a record of data relating to the value of a detectable characteristic of each item in the batch or an abstract of said record by a different route from the batch of items;
means (22) for obtaining a sample of items from the batch;
means (22) for deriving from the record or abstract an expected value of the detectable characteristic of the items in the sample; and
means (22) for verifying the batch by comparing the expected value of the detectable characteristic thus derived with the actual value of the detectable characteristic of the items in said sample.

58. A system according to claim 57, further comprising:
means for deriving an expected total value of the detectable characteristic of the items in the batch from the record or abstract; and
means for comparing the expected total value thus derived with the actual total value of the detectable characteristic of the items in the batch.

59. A system according to claim 57 or claim 58, further comprising:
means for deriving an expected number of consecutive items in the batch having the same value of the detectable characteristic as each other from the record or abstract; and
means for comparing the expected number thus derived with the actual number of consecutive items in the batch having said same value of the detectable characteristic as each other.

60. A system according to any one of claims 57 to 59, wherein:
the first party is a mailer, the second party is a postal service and the items in the batch are items of mail.

61. A system according to claim 60, wherein the items of mail each have a postage indicium associated therewith, and the system further comprises:
means for examining the postage indicia of the items of mail sampled from the batch, thereby to derive the actual value of the detectable characteristic of the sampled items for comparison with the expected value of the detectable characteristic derived from the record or abstract.
